(19) United States
(12) Patent Application Publication
(10) Pub. No.: US 2008/0002302 A1
(43) Pub. Date: Jan. 3, 2008

(54) Method and apparatus for head gimbal assembly with improved shock performance in hard disk drive

(76) Inventors: Hae-sung Kwon, San Jose, CA (US); Eo-Jin Hong, San Jose, CA (US); Yun-Sik Han, Cupertino, CA (US); Vinod Sharma, Los Gatos, CA (US); Hyung Jai Lee, Cupertino, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/435,271

(22) Filed: May 15, 2006

(51) Int. Cl. G11B 5/48

(52) U.S. Cl. 360/245.3

(57) ABSTRACT

This invention stems from knowing that a head gimbal assembly has twice as much of its mass centered on its base plate as it has on its slider performs better in terms of resilience to mechanical shock than one with twice as much mass on the slider as on its base plate. The inventors realized that while these two configurations in normal operation are almost identical, during the impulse and after shocks, the slider with the smaller ratio of mass to the base plate performs better. The invention includes manufacturing methods for the head gimbal assembly, the head stack assembly, and the hard disk drive, as well as these items as products of their respective manufacturing processes.

### TECHNICAL FIELD

This invention relates to hard disk drives, in particular, to apparatus and methods for improving performance when experiencing mechanical shock in a head gimbal assembly of the hard disk drive.

### BACKGROUND OF THE INVENTION

Contemporary hard disk drives include an head stack assembly pivoting through an actuator pivot to position one or more read-write heads, embedded in sliders, each over a disk surface. The data stored on the disk surface is typically arranged in concentric tracks. To access the data of a track, a servo controller first positions the read-write head by electrically stimulating the voice coil motor, which couples through the voice coil and an actuator arm to move a head gimbal assembly in lateral positioning the slider close to the track. Once the read-write head is close to the track, the servo controller typically enters an operational mode known as track following. It is during track following mode that the read-write head is used to access the data stored in the track. Micro-actuators provide a second actuation stage for lateral positioning the read-write head during track following mode. They often use an electrostatic effect and/or a piezoelectric effect to rapidly make fine position changes. They have doubled the bandwidth of servo controllers and are believed essential for high capacity hard disk drives from hereon.

The head gimbal assembly includes the slider, the micro-actuator, both coupled through a flexure finger to a load beam. The load beam is flexibly coupled through a hinge to a base plate, which couples the head gimbal assembly to an actuator block. When the hard disk drive is mechanical shocked, say when its container is dropped, usually an impulse occurs, possibly followed by after shocks. These events are mechanically quite different from the normal events of the hard disk drive. In the prior art, two approaches have been used to optimize shock performance. The first minimizes the effective mass of the head gimbal assembly, and the second (which is often used in conjunction with the first) reduces its first bending frequency.

### SUMMARY OF THE INVENTION

The invention involves recognizing an optimal mass distribution for a head gimbal assembly and its effect on reaction forces at the slider and base plate. This can be likened to an athlete learning something central to their sport. They may have achieved success before, but without the central knowledge, they were effectively blind to something that matters. Their probability of success tends to grow the more they understand and apply that central knowledge. This invention stems from recognizing that a head gimbal assembly with twice as much of its mass centered over its base plate as over its slider performs better, is more resilient, to mechanical shock than one with twice the mass over the slider as over its base plate. While these two configurations in normal operation are mechanically almost identical, during the impulse and after shocks, the slider with the smaller ratio of mass to the base plate performs better.

Once recognized this insight was applied to a contemporary head gimbal assembly in use in the assignee's manufacturing enterprise, leading to a focus on the etch region about the slider for the flexure, hinge and load beam, while insuring that over etching around the hinge was minimized, to avoid creating distortions due to temperature and manufacturing process variations. This method creates to a head gimbal assembly with improved shock performance. The head gimbal assembly may further, preferably include a micro-actuator assembly coupled to the slider, preferably employing a piezoelectric effect and/or an electrostatic effect.

The invention includes a manufacturing method for the head gimbal assembly, insuring the mass distributed over the base plate is close to twice the mass distributed over the slider to create the head gimbal assembly with improved shock performance. The hinge may be selected for etching tolerances to minimize the unwanted distortions. The head gimbal assembly is a product of this process. The invention's head stack assembly includes at least one of the head gimbal assemblies. The invention's hard disk drive includes the voice coil motor containing the head stack assembly.

The invention further includes manufacturing methods for the head stack assembly and the hard disk drive as well as these items as products of their respective manufacturing processes.

### BRIEF DESCRIPTION OF THE DRAWINGS

FIGS. 1A to 2B show various aspects of the head gimbal assembly in accord with the invention;

FIG. 3A shows a read head employing a spin valve for use in the slider;

FIG. 3B shows a read head employing a tunneling valve for use in the slider;

FIG. 4A shows some details of the invention's hard disk drive including the head gimbal assembly;

FIG. 4B shows a micro-actuator assembly employing a piezoelectric effect;

FIGS. 5, 6 and 7 show details of the invention's hard disk drive including the head gimbal assembly;

FIG. 8A shows another example of the micro-actuator assembly employing a piezoelectric effect;

FIG. 8B shows another example of the head gimbal assembly; and

FIGS. 9A and 9B show an example of the micro-actuator assembly employing an electrostatic effect.

### DETAILED DESCRIPTION

This invention relates to hard disk drives, in particular, to apparatus and methods for improving performance when experiencing mechanical shock in a head gimbal assembly of the hard disk drive.

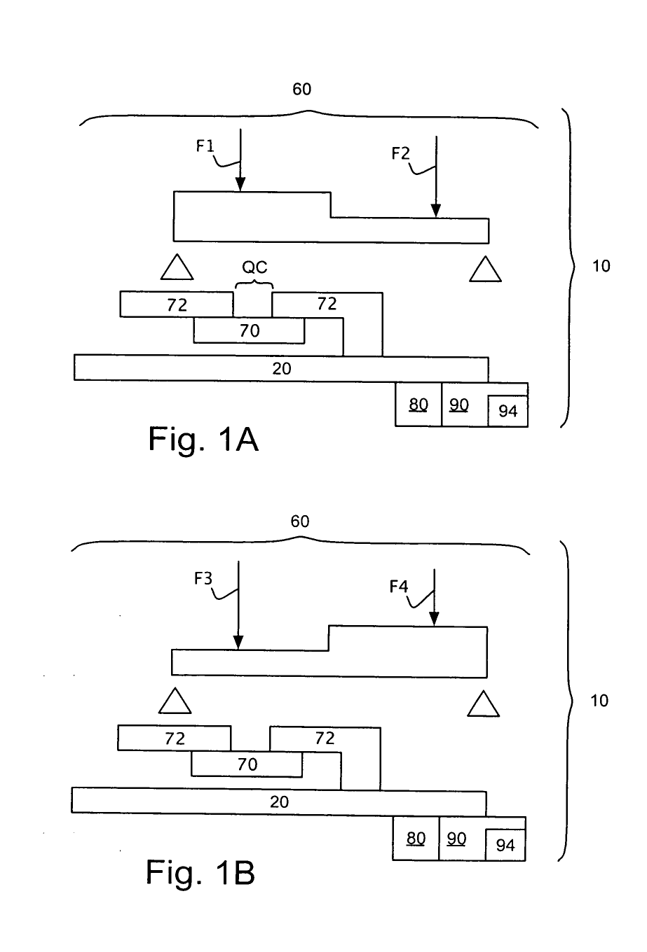

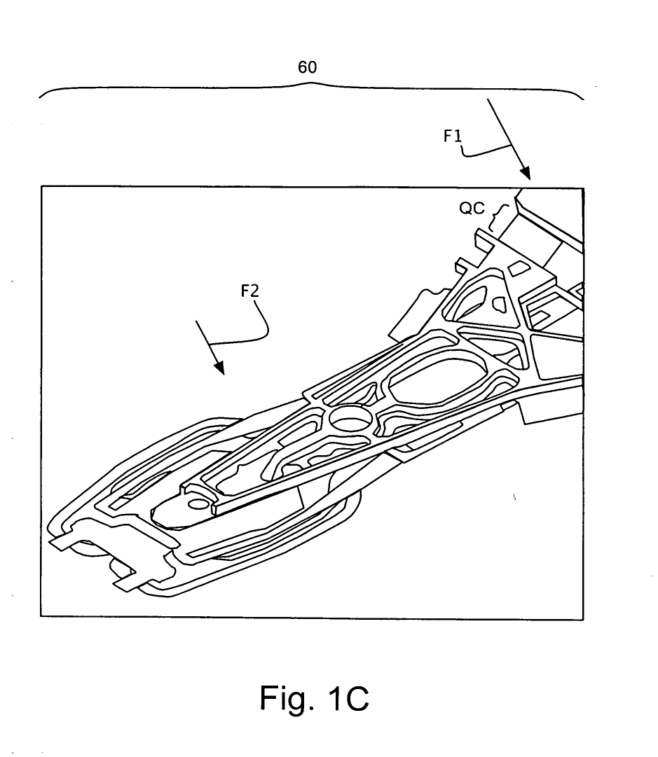

The invention involves the recognition of an optimal mass distribution curve and the effect of the associated reaction forces from the slider 90 and base plate 72 on the head gimbal assembly 60 as a whole. This can be likened to an athlete learning something central to their sport. They may have achieved success before, but without the central knowledge, they were effectively blind to something that matters. Their probability of success tends to grow the more they understand and apply that central knowledge. This invention stems from recognizing that a head gimbal assembly with twice as much of its mass centered over its base plate as over its slider (shown in FIGS. 1A and 1C) performs better, is more resilient, to mechanical shock than one with twice the mass over the slider as over its base plate, as shown in FIG. 1C. While these two configurations in normal operation are mechanically almost identical, during the impulse and after shocks, the slider with the smaller ratio of mass to the base plate performs better.

In FIGS. 1A and 1C, the reaction force at the base plate is denoted by F1 and the reaction force at the slider is denoted by F2. In F1 is greater than F2, making the probability of damage to the slider smaller than the situation in FIG. 1B. In FIG. 1B the reaction force at the base plate is denoted by F3 and the reaction force at the slider is denoted by F4, where F4 is larger than F3. In this situation, the probability of damage to the slider is increased over the situation in FIGS. 1A and 1C.

Once recognized this insight was applied to a contemporary head gimbal assembly 60 in use in the assignee's manufacturing enterprise, leading to a focus on the etch region about the slider 90 for the flexure finger 20, the hinge 70 and the load beam 74, while insuring that over etching around QC the hinge was minimized, to avoid creating distortions due to temperature and manufacturing process variations. This method creates to a head gimbal assembly with improved shock performance.

The head gimbal assembly 60 may further, preferably include a micro-actuator assembly 80, which may employ at least one of the following: a piezoelectric effect and/or an electrostatic effect.

The slider 90, and its read-write head 94 may include a read head 94-R using a spin valve to read the data on the disk surface 120-1, or use a tunneling valve to read the data. The slider may include a vertical micro-actuator 98 for altering the vertical position Vp of the read-write head above the disk surface. The slider may further include the read head providing a read differential signal pair R0 to an amplifier 96 to generate an amplified read signal Ar0 reported by the slider as a result of the read access of the data on the disk surface. The amplifier may be opposite the air bearing surface 92, and may be separate from the deformation region 97, and may further be separate from the vertical micro-actuator 98.

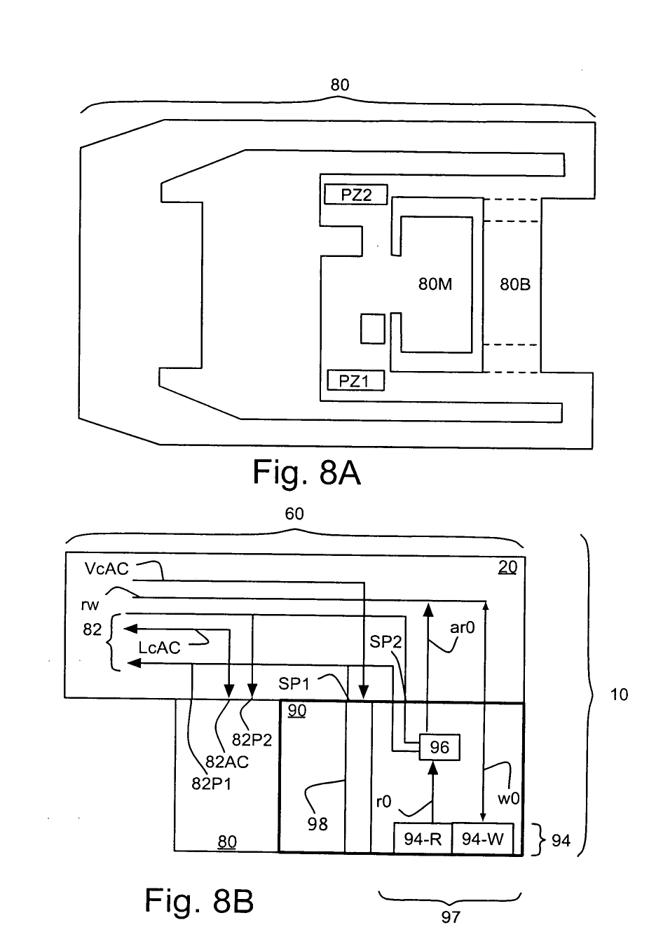

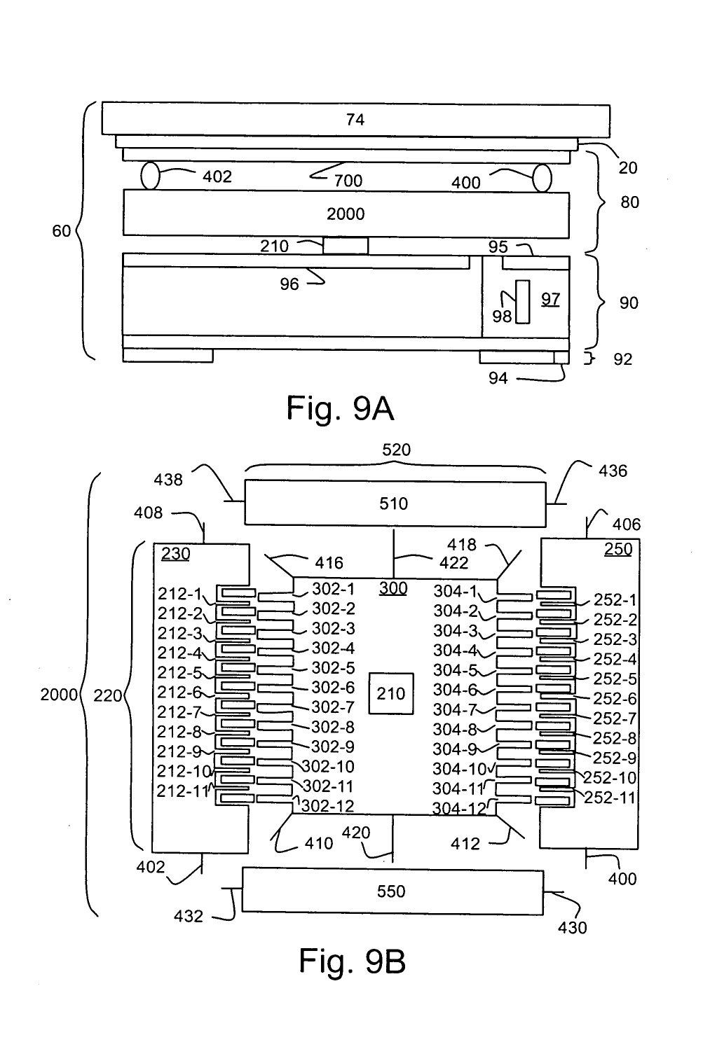

The slider 90 may include a vertical micro-actuator 98, coupled to a deformation region 97 including a read-write head 94 and stimulated by a vertical control signal VcAC providing a potential difference with a first slider power terminal SP1, possibly by heating the deformation region to alter the vertical position Vp of the read-write head over the disk surface 120-1 in a hard disk drive 10 as shown in FIGS. 8C and 9A.

The slider 90 is used to access the data 122 on the disk surface 120-1 in a hard disk drive 10. The data is typically organized in units known as a track 122, which are usually arranged in concentric circles on the disk surface centered about a spindle shaft 40 and alternatively may be organized as joined spiral tracks. Operating the slider to read access the data on the disk surface includes the read head 94-R driving the read differential signal pair r0 to read access the data on the disk surface. The read-write head 94 is formed perpendicular to the air bearing surface 92.

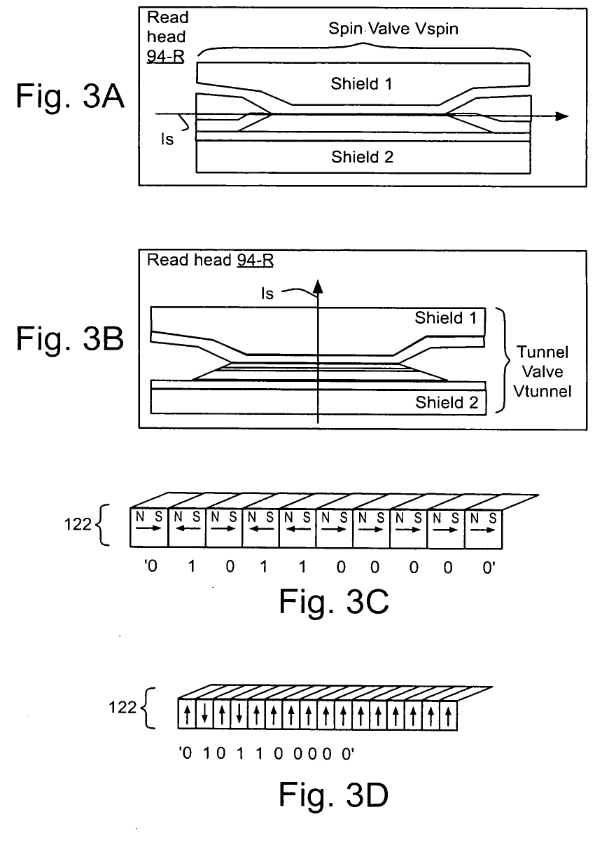

The read head 94-R may use a spin valve to drive the read differential signal pair as shown in FIG. 3A. As used herein, the spin valve employs a magneto-resistive effect to create an induced sensing current Is between the first shield Shield1 and the second shield Shield2. Spin valves have been in use the since the mid 1990's.

The read head 94-R may use a tunnel valve to drive the read differential signal pair as shown in FIG. 3B. As used herein, a tunnel valve uses a tunneling effect to modulate the sensing current Is perpendicular to the first shield Shield1 and the second shield Shield2. Both longitudinally recorded signals as shown in FIG. 3C and perpendicularly recorded signals shown in FIG. 3D can be read by either reader type. Perpendicular versus longitudinal recording relates to the technology of the writer/media pair, not just the reader.

The tunnel valve is used as follows. A pinned magnetic layer is separated from a free ferromagnetic layer by an insulator, and is coupled to a pinning antiferromagnetic layer. The magneto-resistance of the tunnel valve is caused by a change in the tunneling probability, which depends upon the relative magnetic orientation of the two ferromagnetic layers. The sensing current Is, is the result of this tunneling probability. The response of the free ferromagnetic layer to the magnetic field of the bit of the track 122 of the disk surface 120-1, results in a change of electrical resistance through the tunnel valve.

The slider 90 may further include the read-write head 94 providing the read-differential signal pair r0 to the amplifier 96 to generate the amplified read signal ar0, as shown in FIG. 8B. The read-write head preferably includes a read head 94-R driving the read differential signal pair r0 and a write head 94-W receiving a write differential signal pair w0. The slider reports the amplified read signal as a result of read access of the data on the disk surface. In most but not necessarily all of the embodiments of the invention's slider, the amplifier is preferably opposite the air bearing surface 92. The amplified read signal ar0 may be implemented as an amplified read signal pair ar0+− or as a single ended read signal. The vertical micro-actuator 98 included in the slider may operate by inducing a strain on the deformation region 97 as well as any other materials directly coupled to it, making it preferable for the amplifier to be separated from the vertical micro-actuator and the deformation region. These embodiments of the invention's slider preferably include a first slider power terminal SP1 and a second slider power terminal SP2 collectively used to power the amplifier in generating the amplified read signal ar0.

The flexure finger may include the micro-actuator assembly for mechanically coupling to an embodiment of the slider. The flexure finger may include a vertical control signal path providing the vertical control signal to the slider and the heating element. The micro-actuator assembly may aid in lateral positioning, and may further aid in vertical positioning of the read-write head over the data of the disk surface. The micro-actuator assembly may employ a piezoelectric effect and/or an electrostatic effect to aid in positioning the read-write head.

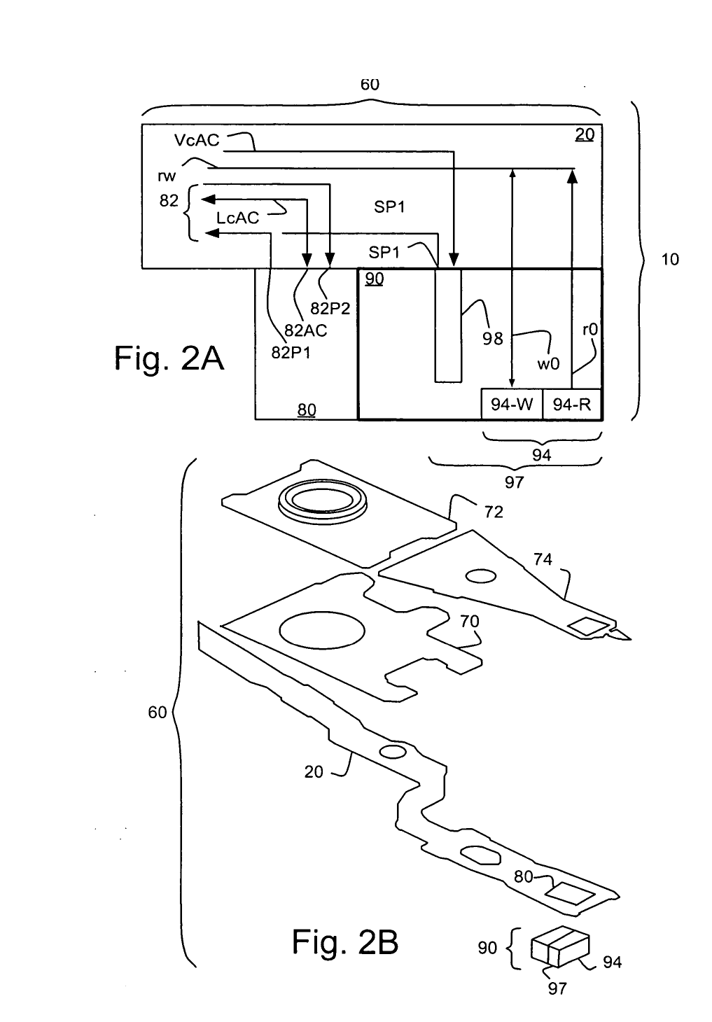

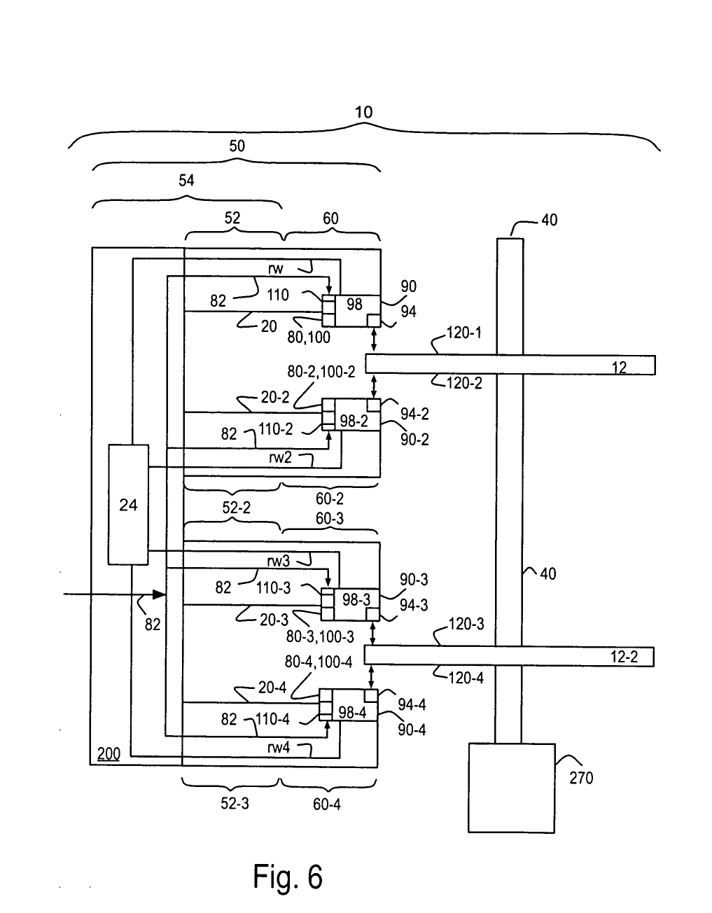

The flexure finger 20 for the slider 90 of FIGS. 1A, 1B, 2A, 2B, 4A to 6, and 8B, preferably contains a micro-actuator assembly 80 for mechanically coupling to the slider to aid in positioning the slider to access the data 122 on 120-1 disk surface of the disk 12. The micro-actuator assembly may aid in laterally positioning LP the slider to the disk surface as shown in FIG. 10A and/or aid in vertically positioning VP the slider as shown in FIG. 6. The flexure finger 20 may further provide the vertical control signal VcAC and preferably the first lateral control signal 82P1 as the first slider power terminal SP1 to the vertical micro-actuator.

The flexure finger 20 preferably includes the lateral control signal 82 and trace paths between the slider for the write differential signal pair w0. The lateral control signal preferably includes the first lateral control signal 82P1 and the second lateral control signal 82P2, as well as the AC lateral control signal 82AC. When the slider does not contain an amplifier 96, as shown in FIGS. 6, 9A and 11, the flexure finger further preferably provides trace paths for the read differential signal pair r0.

The micro-actuator assembly 80 may employ a piezoelectric effect and/or an electrostatic effect to aid in positioning the slider 90. First, examples of micro-actuator assemblies employing the piezoelectric effect will be discussed followed by electrostatic effect examples. In several embodiments of the invention the micro-actuator assembly may preferably couple with the head gimbal assembly 60 through the flexure finger 20, as shown in FIGS. 9A, 9B, 6 and 13B. The micro-actuator assembly may further couple through the flexure finger to a load beam 74 to the head gimbal assembly and consequently to the head stack assembly 50.

Examples of micro-actuator assemblies employing the piezoelectric effect are shown in FIGS. 8C and 13A. FIG. 8C shows a side view of a head gimbal assembly with a micro-actuator assembly 80 including at least one piezoelectric element PZ1 for aiding in laterally positioning LP of the slider 90. In certain embodiments, the micro-actuator assembly may consist of one piezoelectric element. The micro-actuator assembly may include the first piezoelectric element and a second piezoelectric element PZ2, both of which may preferably aid in laterally positioning the slider. In certain embodiments, the micro-actuator assembly may be coupled with the slider with a third piezoelectric element PZ3 to aid in the vertically positioning the slider above the disk surface 120-1.

Examples of the invention using micro-actuator assemblies employing the electrostatic effect are shown in FIGS. 14A and 14B derived from the Figures of U.S. patent application Ser. No. 10/986,345, which is incorporated herein by reference. FIG. 14A shows a schematic side view of the micro-actuator assembly 80 coupling to the flexure finger 20 via a micro-actuator mounting plate 700. FIG. 14B shows the micro-actuator assembly using an electrostatic micro-actuator assembly 2000 including a first electrostatic micro-actuator 220 to aid the laterally positioning LP of the slider 90. The electrostatic micro-actuator assembly may further include a second electrostatic micro-actuator 520 to aid in the vertically positioning VP of the slider.

The first micro-actuator 220 includes the following. A first pivot spring pair 402 and 408 coupling to a first stator 230. A second pivot spring pair 400 and 406 coupling to a second stator 250. A first flexure spring pair 410 and 416, and a second flexure spring pair 412 and 418, coupling to a central movable section 300. A pitch spring pair 420-422 coupling to the central movable section 300. The central movable section 300 includes signal pair paths coupling to the write differential signal pair W0 and either the read differential signal pair r0 or the amplified read signal ar0 of the read-write head 94 of the slider 90.

The bonding block 210 may electrically couple the read-write head 90 to the amplified read signal ar0 and write differential signal pair W0, and mechanically couples the central movable section 300 to the slider 90 with read-write head 94 embedded on or near the air bearing surface 92 included in the slider.

The first micro-actuator 220 aids in laterally positioning LP the slider 90, which can be finely controlled to position the read-write head 94 over a small number of tracks 122 on the disk surface 120-1. This lateral motion is a first mechanical degree of freedom, which results from the first stator 230 and the second stator 250 electrostatically interacting with the central movable section 300. The first micro-actuator 220 may act as a lateral comb drive or a transverse comb drive, as is discussed in detail in the incorporated United States Patent Application.

The electrostatic micro-actuator assembly 2000 may further include a second micro-actuator 520 including a third stator 510 and a fourth stator 550. Both the third and the fourth stator electostatically interact with the central movable section 300. These interactions urge the slider 90 to move in a second mechanical degree of freedom, aiding in the vertically positioning VP to provide flying height control. The second micro-actuator may act as a vertical comb drive or a torsional drive, as is discussed in detail in the incorporated United States Patent Application. The second micro-actuator may also provide motion sensing, which may indicate collision with the disk surface 120-1 being accessed.

The central movable section 300 not only positions the read-write head 10, but may act as the conduit for the write differential signal pair w0 and in certain embodiments, the first slider power signal SP1 and the second slider power signal SP2, as well as the read differential signal pair r0 or the amplified read signal ar0. The electrical stimulus of the first micro-actuator 220 is provided through some of its springs.

The central movable section 300 may preferably to be at ground potential, and so does not need wires. The read differential signal pair r0, the amplified read signal ar0, the write differential signal pair w0 and/or the slider power signals SP1 and SP2 traces may preferably be routed with flexible traces all the way to the load beam 74 as shown in FIG. 14A.

The flexure finger 20 may further provide a read trace path rtp for the amplified read signal ar0, as shown in FIG. 13B. The slider 90 may further include a first slider power terminal SP1 and a second slider power terminal SP2, both electrically coupled to the amplifier 96 to collectively provide power to generate the amplified read signal ar0. The flexure finger may further include a first power path SP1P electrically coupled to the first slider power terminal SP1 and/or a second power path SP2P electrically coupled to the second slider power terminal SP2, which are collectively used to provide electrical power to generate the amplified read signal.

The head gimbal assembly preferably includes the invention's flexure finger coupled to the slider, which further includes the micro-actuator assembly mechanically coupled to the slider and may further include the vertical control signal path electrically coupled to the vertical control signal of the slider. The invention's head stack assembly includes at least one of the head gimbal assemblies coupled to a head stack. The invention's hard disk drive includes a head stack assembly, which includes at least one of the head gimbal assemblies.

Returning to the head gimbal assembly 60, it may include the flexure finger 20 coupled with the slider 90 and a micro-actuator assembly 80 mechanically coupling to the slider to aid in positioning the slider to access the data 122 on the disk surface 120-1. The micro-actuator assembly may further include a first micro-actuator power terminal 82P1 and a second micro-actuator power terminal 82P2. The head gimbal assembly may further include the first micro-actuator power terminal electrically coupled to the first power path SP1P and/or the second micro-actuator power terminal electrically coupled to the second power path SP2P. Operating the head gimbal assembly may further preferably include operating the micro-actuator assembly to aid in positioning the slider to read access the data on the disk surface, which includes providing electrical power to the micro-actuator assembly.

The head gimbal assembly 60 may further provide the vertical control signal VcAC to the heating element of the vertical micro-actuator 98, as shown in FIGS. 6 and 13B. Operating the head gimbal assembly may further preferably include driving the vertical control signal. The first micro-actuator power terminal 82P1 may be tied to the first slider power terminal SP1, and both electrically coupled to the first power path SP1P.

The head gimbal assembly 60 may further include the amplifier 96 to generate the amplified read signal ar0 using the first slider power terminal SP1 and the second slider power terminal SP2. The flexure finger 20 may further contain a read trace path rtp electrically coupled to the amplified read signal ar0, as shown in FIG. 13B. The head gimbal assembly operates as follows when read accessing the data 122, preferably organized as the track 122, on the disk surface 120-1. The slider 90 reports the amplified read signal ar0 as the result of the read access.

The flexure finger 20 may be coupled to the load beam 74 as shown in FIGS. 9B and 14A, which may further include the first power path SP1P electrically coupled to a metallic portion of the load beam. In certain embodiments, the metallic portion may be essentially all of the load beam.

In further detail, the head gimbal assembly 60 includes a base plate 72 coupled through a hinge 70 to a load beam 74. Often the flexure finger 20 is coupled to the load beam and the micro-actuator assembly 80 and slider 90 are coupled through the flexure finger to the head gimbal assembly. The load beam may preferably electrically couple to the slider to the first slider power terminal SP1, and may further preferably electrically couple to the micro-actuator assembly to form the first power path SP1P.

The invention includes a manufacturing method for the head gimbal assembly, comprising insuring the mass distributed over the base plate 72 is close to twice the mass distributed over the slider 90 to create the head gimbal assembly 60 with improved shock performance. The method may further include using a hinge 70 selected for etching tolerances QC to minimize the unwanted distortions. In many manufacturing processes the steps of this method may preferably be implemented as quality control steps. The invention includes the head gimbal assembly as a product of this process.

Manufacturing the invention's head gimbal assembly 60 preferably further includes includes coupling the flexure finger 20 to the slider 90, which further includes mechanically coupling the micro-actuator assembly 80 to the slider and may further include electrically coupling the flexure finger to provide the vertical control signal VcAC to the slider. Coupling the flexure finger 20 to the slider 90 may further include electrically coupling the read trace path rtp with the amplified read signal ar0. Coupling the micro-actuator assembly to the slider may include electrically coupling the first micro-actuator power terminal 82P1 to the first slider power terminal SP1P and/or electrically coupling the second micro-actuator power terminal 82P2 to the second slider power terminal SP2P.

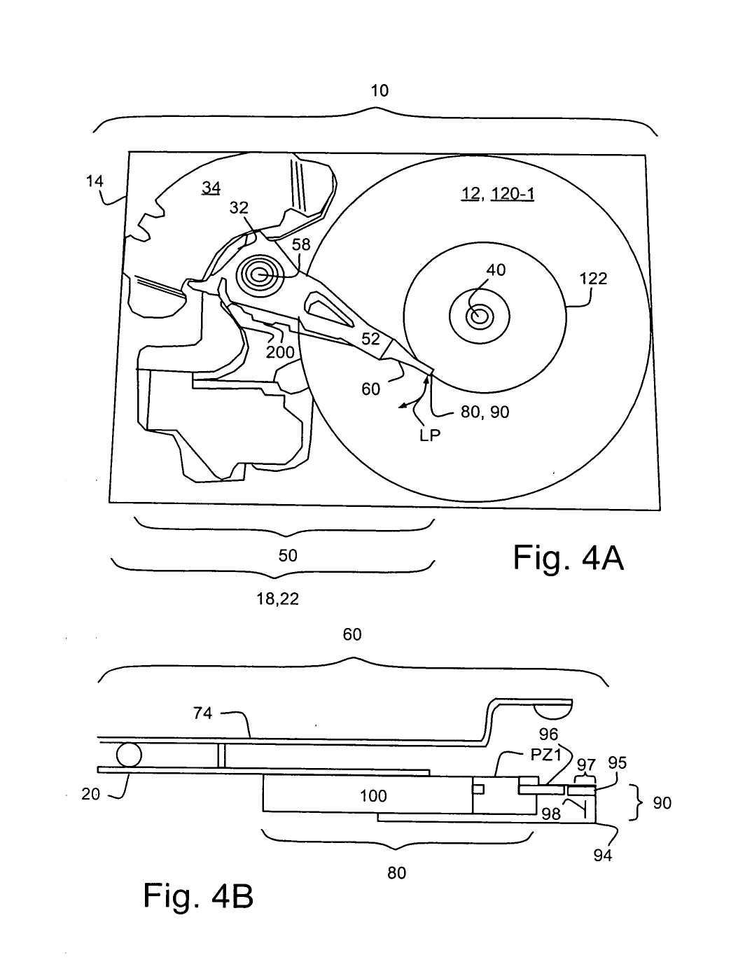

The invention also includes a head stack assembly 50 containing at least one head gimbal assembly 60 coupled to a head stack 54, as shown in FIGS. 4A, 5, and 6.

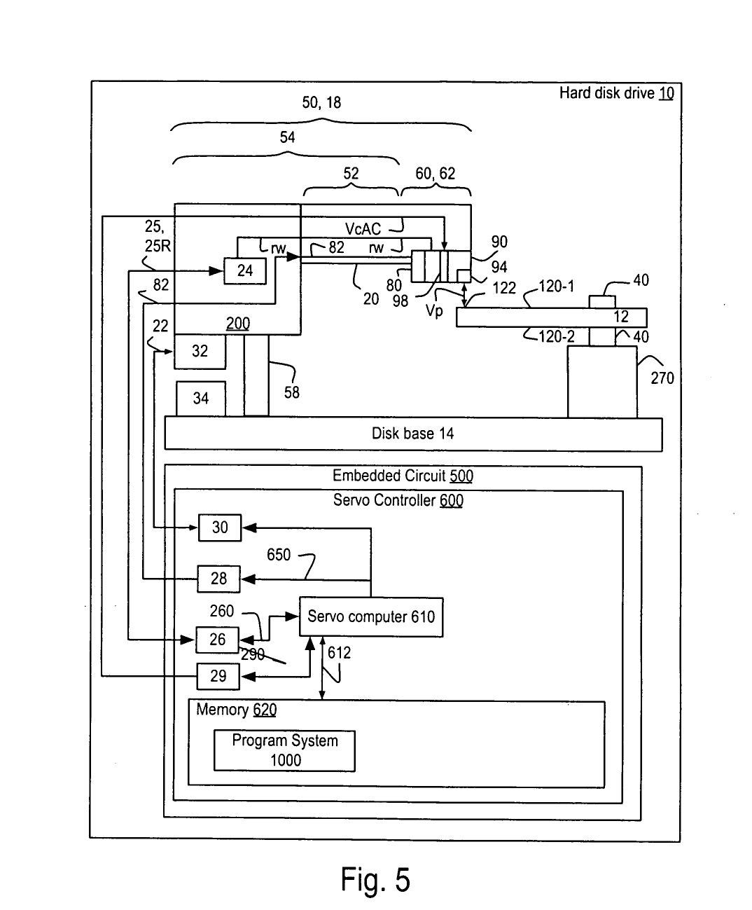

The head stack assembly 50 may include more than one head gimbal assembly 60 coupled to the head stack 54. By way of example, FIG. 6 shows the head stack assembly coupled with a second head gimbal assembly 60-2, a third head gimbal assembly 60-3 and a fourth head gimbal assembly 60-4. Further, the head stack is shown in FIGS. 4A and 5 includes the actuator arm 52 coupling to the head gimbal assembly. In FIG. 6, the head stack further includes a second actuator arm 52-2 and a third actuator arm 52-3, with the second actuator arm coupled to the second head gimbal assembly 60-2 and a third head gimbal assembly 60-3, and the third actuator arm coupled to the fourth head gimbal assembly 60-4. The second head gimbal assembly includes the second slider 90-2, which contains the second read-write head 94-2. The third head gimbal assembly includes the third slider 90-3, which contains the third read-write head 94-3. And the fourth head gimbal assembly includes a fourth slider 90-4, which contains the fourth read-write head 94-4.

The head stack assembly 50 preferably operates as follows: for each of the sliders 90 included in each of the head gimbal assemblies 60 of the head stack, when the temperature of the shape memory alloy film of the slider is below the first temperature, the film configures in a first solid phase to the deformation region 97 to create the vertical position VP of that read-write head above its disk surface. Whenever the temperature of the film of the shape memory alloy is above the first temperature, the film configures in a second solid phase to the deformation region increasing the vertical position of the read-write head above the disk surface.

In certain embodiments where the slider 90 includes the amplifier 96, the slider reports the amplified read signal ar0 as the result of the read access to the track 122 on the disk surface 120-1. The flexure finger provides the read trace path rtp for the amplified read signal, as shown in FIG. 8C. The head stack assembly 50 may include a main flex circuit 200 coupled with the flexure finger 20, which may further include a preamplifier 24 electrically coupled to the read trace path rtp in the read-write signal bundle rw to create the read signal 25-R based upon the amplified read signal as a result of the read access.

Manufacturing the invention's head stack assembly 50 includes coupling at least one of head gimbal assembly 60 to the head stack 50 to at least partly create said head stack assembly. The manufacturing process may further include coupling more than one head gimbal assemblies to the head stack. The manufacturing may further, preferably include coupling the main flex circuit 200 to the flexure finger 20, which further includes electrically coupled the preamplifier 24 to the read trace path rtp to provide the read signal 25-R as a result of the read access of the data 122 on the rotating disk surface 120-1. The invention includes the manufacturing process for the head stack assembly and the head stack assembly as a product of the manufacturing process. The step coupling the head gimbal assembly 60 to the head stack 50 may further, preferably include swaging the base plate 72 to the actuator arm 52.

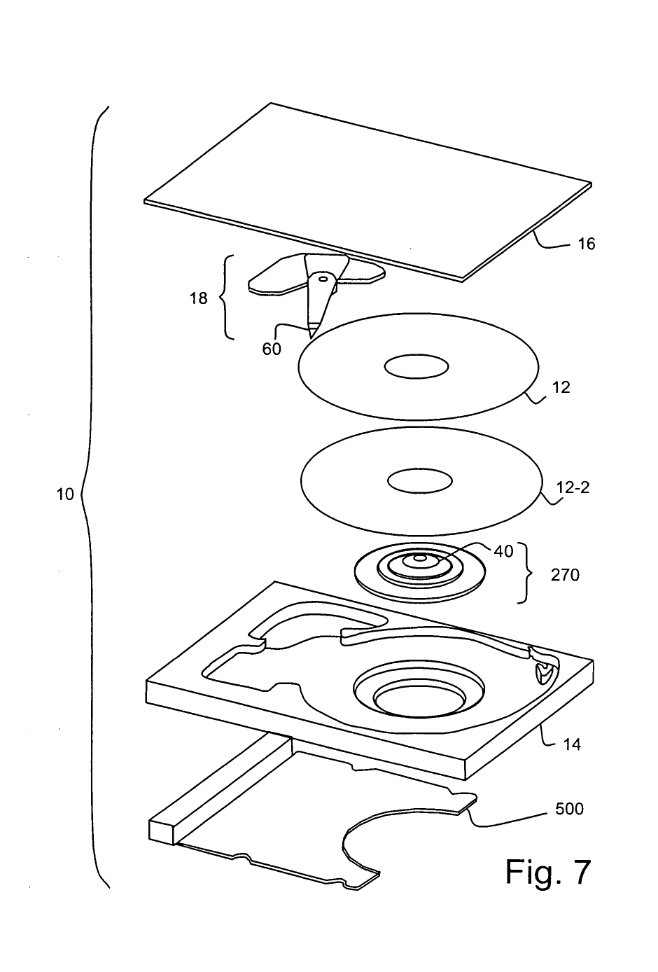

The invention's hard disk drive 10, shown in FIGS. 1A, 1B, 2A, 4A, 5, 6, 7, and 8B includes the head stack assembly 50 pivotably mounted through the actuator pivot 58 on a disk base 14 and arranged for the slider 90 of the head gimbal assembly 60 to be laterally positioned LP near the data 122 for the read-write head 94 to access the data on the disk surface 120-1. The disk 12 is rotatably coupled to the spindle motor 270 by the spindle shaft 40. The head stack assembly is electrically coupled to the embedded circuit 500.

The embedded circuit 500 may preferably include the servo controller 600, as shown in FIG. 6, which may further include a servo computer 610 accessibly coupled 612 to a memory 620. A servo program system 1000 may direct the servo computer in implementing the method operating the hard disk drive 10. The servo program system preferably includes at least one program step residing in the memory. The embedded circuit may preferably be implemented with a printed circuit technology. The lateral control signal 82 may preferably be generated by a micro-actuator driver 28. The lateral control signal preferably includes the first lateral control signal 82P1 and the second lateral control signal 82P2, as well as the AC lateral control signal 82AC. The lateral control signal may further include one or more second micro-actuator lateral control signals 82A.

The voice coil driver 30 preferably stimulates the voice coil motor 18 through the voice coil 32 to provide coarse position of the slider 90, in particular, the read head 94-R near the track 122 on the disk surface 120-1.

The embedded circuit 500 may further process the read signal 25-R during the read access to the data 122 on the disk surface 120-1. The slider 90 reports the amplified read signal ar0 as the result of a read access of the data 122 on the disk surface 120-1. The flexure finger 20 provides the read trace path rtp for the amplified read signal, as shown in FIG. 8C. The main flex circuit 200 receives the amplified read signal from the read trace path to create the read signal 25-R. The embedded circuit receives the read signal to read the data on the disk surface.

Manufacturing the hard disk drive 10 may include pivotably mounting the head stack assembly 50 by an actuator pivot 58 to the disk base 14 and arranging the head stack assembly, the disk 12, and the spindle motor 270 for the slider 90 of the head gimbal assembly 60 to access the data 122 on the disk surface 120-1 of the disk 12 rotatably coupled to the spindle motor, to at least partly create the assembled hard disk drive 9. The invention includes this manufacturing process and the hard disk drive as a product of that process.

Manufacturing the assembled hard disk drive 9 may further include electrically coupling the head stack assembly 50 to the embedded circuit 500 to provide the read signal 25-R as the result of the read access of the data 122 on the disk surface 120-1. It may further include coupling the servo controller 600 and/or the embedded circuit 500 to the voice coil motor 18 and providing the micro-actuator stimulus signal 650 to drive the micro-actuator assembly 80. And electrically coupling the vertical control driver of the embedded circuit to the vertical control signal VcAC of the slider 90 through the head stack assembly 50, in particular through the flexure finger 20.

The read-write head 94 interfaces through a preamplifier 24 on a main flex circuit 200 using a read-write signal bundle rw typically provided by the flexure finger 20, to a channel interface 26 often located within the servo controller 600. The channel interface often provides the Position Error Signal 260 (PES) within the servo controller. It may be preferred that the micro-actuator stimulus signal 650 be shared when the hard disk drive includes more than one micro-actuator assembly. It may be further preferred that the lateral control signal 82 be shared. Typically, each read-write head interfaces with the preamplifier using separate read and write signals, typically provided by a separate flexure finger. For example, the second read-write head 94-2 interfaces with the preamplifier via a second flexure finger 20-2, the third read-write head 94-3 via the a third flexure finger 20-3, and the fourth read-write head 94-4 via a fourth flexure finger 20-4.

During normal disk access operations, the hard disk drive 10 operates as follows when accessing the data 122 on the disk surface 120-1. The spindle motor 270 is directed by the embedded circuit 500, often the servo-controller 600, to rotate the disk 12, rotating the disk surface for access by the read-write head 94. The embedded circuit, in particular, the servo controller drives the voice coil driver 30 to create the voice coil control signal 22, which stimulates the voice coil 32 with an alternating current electrical signal, inducing a time-varying electromagnetic field, which interacts with the fixed magnet 34 to move the voice coil parallel the disk base 14 through the actuator pivot 58, which alters the lateral position LP of the read-write head of the slider 90 in the head gimbal assembly 60 coupled to the actuator arm 52, which is rigidly coupled to the head stack 54 pivoting about the actuator pivot. Typically, the hard disk drive first enters track seek mode, to coarsely position the read-write head near the data, which as stated above, is typically organized as a track. Once the read-write head is close to the track, track following mode is entered. Often this entails additional positioning control provided by the micro-actuator assembly 80 stimulated by the lateral control signal 82, which is driven by the micro-actuator driver 28. In certain embodiments of the hard disk drive supporting triple stage actuation, the second micro-actuator 80A may be further stimulated by one or more second micro-actuator lateral control signals 82A. Reading the track may also include generating a Position Error Signal 260, which is used by the servo controller as positioning feedback during track following mode. The PES signal may be converted into an internal numeric format to create the PES pre-RRO 310 signal shown in FIGS. 5 and 6.

The hard disk drive 10 may operate by driving the vertical control signal VcAC to stimulate the vertical micro-actuator 98 to increase the vertical position VP of the slider 90 by providing a potential difference to the first slider terminal SP1. This operation may be performed when seeking a track 122 of data on the disk surface 120-1, and/or when following the track on the disk surface. The servo controller 600 may include means for driving the vertical control signal, which may be at least partly implemented by the vertical control driver 29 creating the vertical control signal to be provided to the vertical micro-actuator. The vertical control driver is typically an analog circuit with a vertical position digital input 290 driven by the servo computer 610 to create the vertical control signal.

The preceding embodiments provide examples of the invention and are not meant to constrain the scope of the following claims.

What is claimed is:

1. A method of manufacturing a head gimbal assembly for use in a hard disk drive, comprising the steps:
determining the mass distributed over a base plate and the mass distributed over a slider; wherein said head gimbal assembly includes said base plate and said slider; and
insuring that said mass distributed over said base plate is at least one and a half times the mass distributing over said slider to create said head gimbal assembly.

2. The method of claim 1, further comprising the step:
insuring the hinge is not over etched to further create said head gimbal assembly

3. The head gimbal assembly as a product of the process of claim 1.

4. A head stack assembly, including at least one of said head gimbal assemblies of claim 3 coupled to at least one actuator arm of a head stack.

5. A method of manufacturing said head stack assembly of claim 4, comprising the step:
coupling said head stack to said at least one head gimbal assembly through coupling said at least one head gimbal assembly to said at least one actuator arm.

6. The head stack assembly as a product of the process of claim 5.

7. The hard disk drive, comprising:
said head stack assembly of claim 4 coupling to a voice coil placed between fixed magnets mounted on the disk base, with said head stack assembly pivotably mounted through its actuator pivot to said disk base.

8. A method of manufacturing said hard disk drive of claim 7, comprising the steps:
coupling said head stack assembly to a voice coil and placed between said fixed magnets mount on said disk base to create a voice coil motor; and
pivotably mounting said head stack assembly through said actuator pivot to said disk base to create said hard disk drive.

9. The hard disk drive as a product of the process of claim 8.

10. The hard disk drive of claim 7, further comprising a disk surface storing data magnetically oriented as a member of the group consisting of: perpendicular to the plane of said disk surface and parallel said plane of said disk surface.

11. The head gimbal assembly of claim 3, wherein said slider includes a read head employing a member of the group consisting of: a spin valve and a tunneling valve.

12. The head gimbal assembly of claim 3, further comprising a micro-actuator mechanically coupled to said slider to alter its position when following a track on a rotating disk surface in said hard disk drive.

13. The head gimbal assembly of claim 12, wherein said micro-actuator employs at least one member of the group consisting of: a piezoelectric effect, an electrostatic effect.
